(19) United States
(12) Patent Application Publication
(10) Pub. No.: US 2022/0298078 A1
(43) Pub. Date: Sep. 22, 2022

(54) ARTICLE MADE OF CONGLOMERATE MATERIAL, COMPOSITE ASSEMBLY COMPRISING SUCH ARTICLE AND METHOD FOR MANUFACTURING THE ARTICLE MADE OF CONGLOMERATE MATERIAL

(71) Applicant: Luca Toncelli, Bassano del Grappa (VI) (IT)

(72) Inventor: Luca Toncelli, Bassano del Grappa (VI) (IT)

(21) Appl. No.: 17/619,749

(22) PCT Filed: Jun. 26, 2020
(86) PCT No.: PCT/IB2020/056065

§ 371 Date: Dec. 16, 2021

(30) Foreign Application Priority Data
Jun. 27, 2019 (IT) 102019000010338

(51) Int. Cl. C04B 28/26; C04B 14/24; C04B 14/12; C04B 22/00; C04B 22/06

(52) U.S. Cl. CPC C04B 28/26; C04B 14/24; C04B 14/12; C04B 22/0093; C04B 22/06; C04B 2103/30

(57) ABSTRACT

Article made of conglomerate material comprising an aggregate comprising granules of expanded glass or expanded ceramic/clay and defining between them intergranular cavities, and a binder. The binder is present in the minimum quantity necessary for coating the expanded glass or expanded ceramic/clay granules, and the intergranular cavities contain only air and are free from filler material. Moreover, the binder is present in a volumetric quantity comprised between 6% and 12% of the total volume of the article.

The present invention relates to the production of articles made of conglomerate material and in particular the production of articles from a mix comprising granules of expanded inert material and a binder.

The present invention also relates to a composite assembly comprising the article made of conglomerate material and a method for manufacturing articles made of conglomerate material.

For some time a process for the manufacture of compact, non-porous articles, preferably in slab form, also known as Bretonstone® technology, has been known, wherein an initial mix consisting of a granular material with a selected particle size, a filler in powder form and a hardening resin is prepared.

The granular material is preferably stone material or inorganic stone-like material and the resin is chosen from the group comprising polyester, acrylic, epoxy, polyurethane and other resins.

The mix is deposited on a temporary support or on a mould and is subjected to a vacuum compression step, with simultaneous application of a vibratory motion at a predetermined frequency.

This is followed by a step involving hardening of the resin, at the end of which the article has the desired mechanical characteristics. The resultant slab is then subjected to the subsequent finishing steps (sizing, smoothing, polishing and the like).

Alternatively, or in addition, the mix may contain an expanded granular material, such as for example expanded glass and/or expanded clay, and/or a filler also composed of expanded material. This latter composition helps reduce the specific weight of the finished article, which is in any case compact and non-porous.

From IT1350446 a process is known for the manufacture of compact and non-porous conglomerate articles from expanded granular material, such as for example expanded glass and expanded clay.

Optionally, the articles of conglomerate material thus obtained may be combined with a cladding panel or sheet, made of a material which may also be different from the material of the article.

In this configuration it is necessary for the article and the cladding panel to have similar thermal expansion coefficients, in such a way as to avoid distortions associated with temperature variations.

By using polyester, acrylic, epoxy and polyurethane resins good-quality articles with specific characteristics that distinguish them from traditional products may be obtained.

In particular, the most widespread articles are those formed from conglomerate material and from polyester resins diluted with a solvent containing styrene, said resins allowing particularly low-cost articles with outstanding technical characteristics to be obtained.

One drawback of these known solutions consists in the fact that the article obtained with a solvent-containing polyester resin tends to yellow if subjected to a heating step or to ultraviolet rays.

It is evident that this drawback has an effect on the aesthetic features of the article, particularly in the case of articles to be used as external cladding for buildings.

Another drawback of these known solutions consists in the fact that the presence of the monomer styrene as a reactive solvent contained in the resin, and therefore in the mix, poses various environmental and health problems during production of the articles, associated with its harmfulness and the risk of explosion due to its high volatility.

The use of styrene in the production process, in fact, requires the presence of particularly sophisticated and costly vapour capturing and abatement plants in order to comply with increasingly stringent regulations.

Furthermore, in the case of two-component resins, which moreover have a cost about four times that of polyester resins, making them disadvantageous from a cost point of view, there is the further drawback arising from the fact that these resins tend to harden also at room temperature before completion of the article manufacturing procedure and to be deposited on the various parts of the plant creating incrustations.

As a result of this drawback frequent maintenance of the plant is required, i.e. frequent interruption of the production cycle in order to carry out the necessary cleaning operations, thereby increasing the overall production times.

A further drawback consists in the fact that the expanded granular material allows only a limited reduction in the density of the articles to be obtained, these articles therefore having in any case a significant weight. For example, the density of the articles produced in this way may be between 0.9-1.1 g/cm³.

This drawback is particularly problematic in the furniture and building sectors, where the articles must be moved in order to be positioned in the place of use.

In order to overcome at least partially these drawbacks, processes have been developed for the manufacture of articles made of conglomerate material which use binders different from those indicated above.

An example of these processes is described in IT1359243, which envisages the use of a binder consisting of an aqueous suspension of colloidal silica, also known as silica sol.

In particular, the binder is formed by a dispersion in the aqueous phase of particles of colloidal silica of nanometric size.

The granular material of the article may be an expanded inert material, preferably expanded glass, and the composition of the article may include a filler and a plasticizer.

The filler comprises hollow inorganic microspheres while the plasticizer may be chosen from the group comprising clay, quartz or other powder material.

The process for production of these articles involves, in a manner known per se, a step for compacting, preferably by means of vacuum vibro-compression, the mix deposited on a mould or temporary support, in order to obtain a rough-finished slab.

Subsequently, the rough-finished slab is heated with a predetermined temperature gradient up to a temperature of between 80° C. and 120° C. for a few hours, in such a way as to evaporate almost completely the water present in the slab.

However, a drawback of this solution consists in the fact that the process thus carried out, in combination with the materials used, is able to achieve only a limited reduction in the weight of the article.

Another drawback consists in the fact that the use of the filler, while improving the mechanical characteristics of the slabs, makes the slab production process more complex and expensive.

A further drawback consists in the fact that the finished article has a limited water resistance and limited mechanical strength.

One object of the present invention is to provide an article made of conglomerate material, a composite assembly comprising such article and a method for manufacturing the article which are able to overcome the above-mentioned drawbacks.

In particular, the main object of the present invention is to provide an article made of conglomerate material which has a significantly lower specific weight compared to the articles known in the sector.

Another object of the present invention is to provide an article made of conglomerate material which has a mechanical strength sufficient for allowing use thereof in the architecture, furniture and building sectors and which is not particularly costly.

A further object of the present invention is to provide an article made of conglomerate material which has a coefficient of linear thermal expansion such as to allow it to be combined with panels made of natural stone, sintered stone, ceramic or coloured glass, avoiding distortions caused by temperature variations.

Another object of the present invention is to provide an article made of conglomerate material that has a high resistance to water and high mechanical strength.

The main objects described above are achieved with an article made of conglomerate material according to claim 1, with a composite assembly according to claim 14 and with a method for manufacturing the article according to claim 17.

The article of the present invention is made of conglomerate material and has a porous and non-compact structure which helps reduce the specific weight thereof.

In the preferred embodiment of the present invention, the article is made of conglomerate material and is in the form of a slab. Conveniently, the article in slab form is obtained from a mix deposited on a mould or on a temporary support. The mould or temporary support is of the type known per se and will not be described further hereinbelow. The mix is subsequently compacted, preferably by means of vibro-compression.

However, the article may also be made in the form of a block, using formwork instead of a mould for depositing the mix. In this case, the slabs can be obtained by subsequent sawing of the block in a known manner.

The article comprises an aggregate of inert material in the form of granules of expanded material, which are therefore light and have a selected particle size range, and a binder. In particular, the conglomerate material of the article is obtained from the aggregate of inert material.

The granules are advantageously made of expanded glass or expanded ceramic/clay and are bound together by means of the binder, with the optional addition of a plasticizing additive, described in detail hereinbelow.

Advantageously interstitial cavities, which contain only air, are provided between the granules. These cavities are referred to in the description below by the expression “intergranular cavities”.

The article of the present invention does not envisage the use of a material, for example a paste containing a binder and a filler, for filling the intergranular cavities, which represent 25-35% of the overall volume of the article.

The feature of having a predefined coefficient of linear thermal expansion such as to allow the article to be combined with panels made of natural stone, sintered stone, ceramic or coloured glass, avoiding distortions caused by temperature variations, is also made possible by the particular type of binder used in the starting mix, as explained in detail here below.

Moreover, the presence of air in the intergranular cavities gives the article a reduced capacity for conducting heat and makes the article an effective thermal insulant.

The granules of expanded glass or of expanded ceramic/clay, while having an impermeable surface, have internal cavities that help further lighten the article and reduce its specific weight compared to the articles known in the sector.

The expanded granules preferably have a particle size of between 0.1 and 8.0 mm and are non-permeable spongy spheroidal granules with an average density of between 0.35 and 0.5 g/cm³.

In the present description, the term “spongy” refers to an element having a porous and non-compact internal structure.

The granular material may also have a different density and particle size, provided that it maintains a spongy internal structure as indicated above.

In addition, the binder is preferably an inorganic material, so as to achieve a predefined coefficient of linear thermal expansion, and the article is obtained by means of compaction, preferably by vibro-compression, and hardening of the mix; the manufacturing method will be described in detail in the continuation of the present description.

In accordance with the present invention, the binder is present in the minimum quantity necessary for coating the granules. This quantity of binder is such that it does not fill and saturate the intergranular cavities but is suitable for forming a layer at the interface between the granules.

In order to obtain this technical effect, the binder is a volumetric quantity comprised between 6% and 12% of the total volume of the article.

In one embodiment of the invention the binder is present in a volumetric quantity comprised between 8% and 10% of the total volume of the article.

As indicated above, the binder is an inorganic material, in particular an aqueous dispersion of sodium silicate is used, this being mixed with the granules of expanded material in order to form the mix.

As an alternative to sodium silicate, the binder could also be an aqueous dispersion of potassium silicate, or also an aqueous dispersion of colloidal silica, although these substances give rise to a binder less strong than sodium silicate, which is therefore preferred.

The binder could also be formed by a mixture of the aqueous dispersions of potassium silicate and/or colloidal silica with the aqueous dispersion of sodium silicate.

The hardening, after compaction, of the mix and the binder in order to provide the slab with the necessary consistency, may be carried out by drying the compacted article with evaporation of the free water of the aqueous dispersion, generally accelerated by means of heating and drying with a temperature gradient of up to 100° C. and higher.

The drying process accelerated by means of heating may take several tens of minutes and is generally carried out by allowing the article, i.e. the slab, to rest, compacted but still not solid, on a rigid support surface.

Since the article, which has been compacted but not yet hardened by means of drying, is not solid and has a reduced mechanical consistency, it must be handled with extreme care, particularly during transfer from the mould to the breathable drying support, normally consisting of a rigid metal surface.

Alternatively, there is the possibility of carrying out hardening of the binder in a few seconds without the need to evaporate the water by drying, avoiding therefore the transfer of the compacted article from the temporary moulding support to the drying surface.

In fact, the aqueous dispersion of sodium silicate that acts as binder may undergo a different hardening process by means of reaction with a substance that acts as a weak acid.

Preferably, hardening of the binder is obtained by reaction of the sodium silicate with carbon dioxide which acts as a weak acid.

In this respect, it is pointed out that the carbon dioxide reacting with the sodium silicate gives rise to a compound, so-called ‘silico-carbonate’, which precipitates and causes the binder to solidify and harden on the surface of the granules. The binder therefore forms a layer at the interface between the granules of expanded material.

In particular, it is the aqueous solution of carbon dioxide, which is formed when the carbon dioxide is dissolved in the water of the aqueous dispersion of sodium silicate, which acts as a weak acid in the reaction.

In fact, when the carbon dioxide is dissolved in water, carbonic acid is formed and the pH of the aqueous solution is reduced owing to the dissociation of the H+ and HCO₃_{^{−}} ions.

The carbon dioxide may also be blown inside the intergranular cavities creating a stream, so as to dissolve in the water of the aqueous dispersion of sodium silicate.

It is pointed out that the other classes of inorganic binders mentioned above react with carbon dioxide in the same way as the sodium silicate, causing hardening of the binder.

The measure of inserting the compacted slab resting on its forming support inside a chamber in which air is extracted and a vacuum is created has been found to be particularly advantageous.

In fact, after the creation of the vacuum inside the chamber, the intergranular cavities are found to be practically free of air. At this point, the carbon dioxide is blown into the chamber and diffused inside the intergranular cavities, consequently dissolving in the water of the aqueous dispersion and causing the accelerated hardening of the binder and the mix.

Advantageously, the process may also be carried out more efficiently, for example by carrying out the step of vibro-compression of the mix in a vacuum environment to remove the air from the intergranular cavities; the carbon dioxide is then blown directly into the vibro-compression chamber after compacting the slab, without the need to transfer the slab into another chamber.

In this way, the compacted slab exits the compacting chamber, after evacuation of the residual carbon dioxide, already hardened and with a mechanical consistency such that it can be moved without difficulty; for example, the slab may be transported on a motorized roller conveyor and introduced into a hot air tunnel for drying by means of elimination of the free water by evaporation.

Even if, after elimination of the free water, the slab is sufficiently hardened and solid, i.e. has a good mechanical strength, it nevertheless has a poor resistance to moisture and water, which may result in a kind of regression of the hardening reaction, with consequent flaking of the slab.

To provide instead the dried and hardened slab with a well-defined moisture and water resistance, without any risk of flaking, it is preferable to heat the slab to at least 650° C. with a suitable heating and cooling gradient. Heating the slab to 650° C. may be performed for both the hardening processes described above.

In particular, said heating operation must involve a particularly slow gradient up to about 250° C. in order to extract from the article and gradually eliminate the chemically bonded water still present in the mix.

This water is the residual water which was not eliminated during the previous operation involving heating up to 100° C., which is aimed at evaporating only the free water.

As indicated previously, the binder may optionally comprise a plasticizing agent in powder form, for example chosen from the group comprising metakaolin, kaolin and clays. These plasticizing agents may be present in the binder singly or mixed together.

The plasticizing agent may be added to the binder in quantities equal to approximately 30-60% of its weight.

These plasticizing agents, besides modifying the rheology and plasticity of the mix, may also create pozzolanic reactions that increase the strength of the inorganic binder after hardening.

The plasticizing agent may also consist, wholly or partly, of micronized clinker, or zinc or zinc oxide powder. These plasticizing agents are able to provide the binder with a reasonable water resistance after drying, without the need for the aforementioned step involving heating up to 650° C.

To achieve the aforementioned water resistance effect without heating to 650° C., the binder may also comprise, in addition or instead of the plasticizing agent, an organic additive intended to harden in an aqueous and alkaline environment.

The organic additive may be chosen from the group comprising an acrylic latex, a styrene-butadiene copolymer or an epoxy or polyester resin, or a lignin sulfonate compound.

Moreover, the organic additive may be present in a volumetric quantity comprised between 1% and 3% of the total volume of the article.

This organic additive also helps increase the plasticity of the mix and the mechanical strength of the finished article.

In the presence of the organic additive, the heating step downstream of step d) may be performed at about 110-150° C. depending on the cross-linking temperature of the organic additive.

The composition of the mix and the measures to be taken during the production of the articles determine a coefficient of thermal expansion of the articles which is between 4 and 7 μm/m° C.

This thermal expansion coefficient is of the same order of magnitude as the thermal expansion coefficient of the panels made of natural stone, sintered stone, ceramic or coloured glass.

Therefore, the article obtained according to the invention is particularly suitable for being combined with this type of panel, avoiding distortions that can form following possible temperature variations.

The configuration of the article indicated above also results in a reduction in the density of its structure, which may be advantageously between 0.45 and 0.65 g/cm³, and therefore makes the article lighter than those known in the sector.

This advantage is particularly useful in the architecture, furniture and building sectors, especially when moving the articles.

Advantageously the composition of the binder may comprise further additives, for example colouring or antibacterial additives of the type known per se.

The present invention also relates to a composite assembly comprising the above-described article combined with a cladding panel, which is preferably thin so as not to weigh down the assembly, made of a material different from the conglomerate material of the article.

The article made of conglomerate material and the panel may be joined together by means of a suitable glue or adhesive, in a manner known per se.

Preferably, the panel and the article have a coefficient of linear thermal expansion of the same order of magnitude. In particular, the coefficient of linear thermal expansion of the panel and of the article may be between 4 and 7 μm/m° C. This latter characteristic feature prevents distortions of the composite assembly in response to temperature variations.

In particular, in accordance with that described above, the material of the panel may consist of natural stone, sintered stone, ceramic or coloured glass or a different material, provided that it has a coefficient of linear thermal expansion lying within the aforementioned range.

The panel may preferably have the function of a cladding and a visible surface in the composite assembly.

It is likewise possible to provide the composite assembly with greater mechanical strength by applying a high-resistance element to the non-visible rear face of the lightweight article, and therefore on the opposite side to the cladding panel; for example, it is possible to apply a glass fibre or aramid fibre or carbon fibre mesh or fabric by means of an adhesive resin.

In this case, the lightweight article is placed between the cladding panel and the high-resistance element.

A further subject of the present invention consists of a method for manufacturing the article made of conglomerate material according to the above description.

The method comprises the following steps:

(a) preparation of an initial mix containing granules and a binder, to which a plasticizing agent is optionally added, in the quantity strictly necessary for coating the granules; the binder is an inorganic material, preferably an aqueous dispersion of sodium silicate, and is suitable for undergoing a process of hardening by means of drying or by mean of reaction with carbon dioxide;

(b) depositing the mix on a temporary support or mould;

(c) compacting the mix;

(d) hardening the mix and the binder so as to obtain the article made of conglomerate material.

The granular material used for the preparation of the initial mix consists of granules of expanded glass or expanded ceramic/clay of the type described above with reference to the article.

Advantageously the compacting step c) is carried out by means of vibro-compression of the mix, and the mould or temporary support may have the same dimensions as those of the article to be obtained.

The binder is present in the minimum quantity needed to coat the granules and the intergranular cavities are free of filler material. In particular, the quantity is that indicated previously with reference to the article.

The hardening step d) may be preformed by means of evaporation of the water, optionally accelerated by means of heating and drying of the article or by reaction of the sodium silicate with carbon dioxide that acts as a weak acid.

In particular, it is the aqueous solution of carbon dioxide dissolved in the water of the aqueous dispersion that acts as a weak acid.

For this purpose, a step of blowing of carbon dioxide into the intergranular cavities of the mix is provided; the carbon dioxide dissolves in water and reacts with sodium silicate as a weak acid to form a compound that precipitates and promotes hardening of the binder.

Alternatively, a substance that acts as a weak acid, other than carbon dioxide, may also be used to promote hardening of the binder, provided that this substance can be blown into the cavities of the mix.

It should be noted that the inorganic binder may also be formed by an aqueous dispersion of colloidal silica or potassium silicate, which can react with the carbon dioxide which may be blown in to harden the binder in the same way as the aqueous dispersion of sodium silicate.

As indicated above, the binder is present in a volumetric quantity comprised between 6% and 12%; in one embodiment the volumetric quantity of binder is between 8% and 10%.

Before the step of blowing the carbon dioxide into the intergranular cavities, a step of applying a vacuum to the mix may be provided, in order to remove the air from the intergranular cavities.

The application of the vacuum to the mix in order to remove the air from the intergranular cavities may involve the use of a press for vacuum vibro-compression of the mix, which creates the vacuum before compacting the mix.

The free water of the binder is subsequently eliminated by means of evaporation, preferably with heating and drying of the mix, as indicated above.

In addition, downstream of step d) a step may be performed for heating the article up to 650° C. with a suitable temperature gradient, i.e. one which is particularly slow up to 250° C., so as to allow the elimination of the chemically bonded residual water that has not been removed during the previous heating step.

An organic additive may also be added to the binder as described above, in combination with or instead of the plasticizing agent.

In the presence of the organic additive, the heating step downstream of step d) may be performed at about 110-150° C. depending on the cross-linking temperature of the organic additive.

From that stated above it is now clear how the article made of conglomerate material, the method for manufacture of the article and the composite assembly are able to advantageously achieve the predefined objects.

In particular, it is clear how, with the combination of a particular binder consisting of inorganic material, preferably based on sodium silicate, and an expanded granular material, without the addition of filler material in the intergranular cavities, it is possible to obtain an article made of conglomerate material with a lower specific weight and low thermal expansion.

It should be noted that the article obtained by means of the method forming the subject of the present invention does not comprise any filler material for filling the intergranular cavities, and consequently has a low specific weight. Furthermore, the embodiments described, both of the article and of the manufacturing method, help significantly reduce the complexity and cost of the production plant.

Obviously, the above description of embodiments applying the innovative principles of the present invention has been provided solely by way of a non-limiting example of these innovative principles and must therefore not be regarded as limiting the scope of protection claimed herein.

1. Article made of conglomerate material comprising:
an aggregate comprising granules of expanded glass or expanded ceramic/clay defining between them intergranular cavities;
a binder;
characterized in that said binder is present in the minimum quantity necessary for coating the granules of expanded glass or expanded ceramic/clay and in that the intergranular cavities contain only air and are free of filler material,
said binder being present in a volumetric quantity comprised between 6% and 12% of the total volume of the article.

2. Article according to claim 1, characterized in that said binder is present in a volumetric quantity comprised between 8% and 10% of the total volume of the article.

3. Article according to any one of the preceding claims, characterized in that said binder is an inorganic material.

4. Article according to claim 3, characterized in that said binder is an aqueous dispersion of sodium silicate or an aqueous dispersion of potassium silicate or an aqueous dispersion of colloidal silica, or mixtures thereof.

5. Article according to claim 3, characterized in that said binder comprises at least one plasticizing agent in powder form.

6. Article according to claim 5, characterized in that said plasticizing agent in powder form is added to the binder in a quantity equal to about 30-60% of its weight.

7. Article according to claim 5, characterized in that said plasticizing agent is chosen from the group comprising metakaolin, kaolin and clays, and mixtures thereof.

8. Article according to claim 5, characterized in that said plasticizing agent consists of clinker powder or zinc or zinc oxide powder.

9. Article according to claim 1 or 2, characterized in that said binder comprises an organic additive, said organic additive being intended to harden in an aqueous and alkaline environment.

10. Article according to claim 9, characterized in that said organic additive is chosen from the group comprising an acrylic latex, a styrene-butadiene copolymer, a polyester or epoxy resin, or a lignin sulfonate compound.

11. Article according to claim 9, characterized in that said organic additive is present in a volumetric quantity comprised between 1% and 3% of the total volume of the article.

12. Article according to claim 1, characterized in that said granules of expanded glass or expanded ceramic/clay have a selected particle size range.

13. Article according to claim 12, characterized in that said granules of expanded glass or expanded ceramic/clay are non-permeable cavernous spheroidal granules with an average density of between 0.35 and 0.50 g/cm³ and have a particle size of between 0.1 and 8.0 mm.

14. Composite assembly comprising:
an article of conglomerate material according to any one of claims 1 to 13 in slab form;
a cladding panel made of a material different from the conglomerate material;
wherein said article and said panel are joined together and have respective coefficients of linear thermal expansion which are of the same order of magnitude.

15. Assembly according to claim 14, characterized in that the coefficients of linear thermal expansion of said article and of said panel are comprised between 4 and 7 μm/m° C.

16. Assembly according to claim 14, characterized in that said panel is made of a material chosen from the group comprising natural stone, sintered stone, ceramic and coloured glass.

17. Method for manufacturing articles made of conglomerate material, comprising the following steps:
(a) preparation of an initial mix containing granules of expanded glass or expanded ceramic/clay and a binder to which a plasticizing agent is optionally added;
(b) depositing said mix on a temporary support or on a mould;
(c) compacting said mix;
(d) hardening said mix;
characterized in that said binder is present in the minimum quantity necessary for coating the granules and in that the intergranular cavities formed between the granules contain only air and are free of filler material,
said binder being present in a volumetric quantity comprised between 6% and 12% of the total volume of the article.

18. Method according to claim 17, characterized in that said binder is present in a volumetric quantity comprised between 8% and 10% of the total volume of the article.

19. Method according to claim 17, characterized in that said compacting step is performed by means of vibro-compression.

20. Method according to any one of claim 17 or 18, characterized in that said binder is an inorganic binder and preferably an aqueous dispersion of sodium silicate.

21. Method according to claim 20, characterized in that said step d) takes place by means of reaction with a substance that acts as a weak acid.

22. Method according to claim 21, characterized in that said step d) is performed by blowing carbon dioxide into the intergranular cavities of the mix, the carbon dioxide acting as a weak acid so as to form a compound with said sodium silicate and promote the hardening of said binder, with subsequent evaporation of the free water.

23. Method according to any one of claims 19-20, characterized in that said step d) is performed through evaporation of the water, optionally accelerated by means of heating and drying of the article.

24. Method according to any one of claims 21-23, characterized in that, downstream of said step d), a step is provided for heating the article to 650° C. with an appropriate temperature gradient in order to eliminate the chemically bonded residual water, followed by cooling.

25. Method according to claim 23, characterized in that a plasticizing agent and/or an organic additive is optionally added to said binder.

26. Method according to claim 25, characterized in that, following said step d) by evaporation of the water, a step is provided for heating the article to about 110-150° C. depending on the cross-linking temperature of said organic additive.
